(19) United States
(12) Patent Application Publication
(10) Pub. No.: US 2008/0137729 A1
(43) Pub. Date: Jun. 12, 2008

(54) Storage Medium Including Data Structure For Reproducing Interactive Graphic Streams Supporting Multiple Languages Seamlessly; Apparatus And Method Therefore

(76) Inventor: Kil-Soo Jung, Hwaseong-si (KR)

Correspondence Address: STEIN, MCEWEN & BUI, LLP, 1400 EYE STREET, NW, SUITE 300, WASHINGTON, DC, 20005, US

(21) Appl. No.: 11/908,083

(22) PCT Filed: Mar. 8, 2005
(86) PCT No.: PCT/KR05/00644

§ 371 Date: Sep. 7, 2007

(51) Int. Cl. H04B 1/66

(52) U.S. Cl. 375/240.01

(57) ABSTRACT

A storage medium having a data structure for seamlessly reproducing interactive graphic streams supporting multiple languages, and an apparatus and method therefor are provided. The storage medium includes: a main stream generated by compressing and encoding a multimedia image; and interactive graphic streams multiplexed into the main stream and forming a menu supporting a plurality of languages. The interactive graphic streams include page information on menu pages, and button information on buttons included in each menu page. Accordingly, a menu supporting a language selected by a user can be provided, and even when a switch operation between menus supporting a plurality of languages is performed, seamless reproduction is enabled.

### TECHNICAL FIELD

The present invention relates to the reproduction of a multimedia image, and more particularly, to a storage medium having a data structure for seamlessly reproducing interactive graphic streams supporting multiple languages and an apparatus and method therefor.

### BACKGROUND ART

At present, in a moving picture main stream recorded on a storage medium to provide a multimedia image with a high definition (HD) level picture quality, a video stream, an audio stream, a presentation graphic stream for providing subtitles, and interactive graphic streams for providing buttons or menus for interaction with a user are multiplexed.

Among these streams, the audio stream or the presentation graphic stream can include one or more streams to provide a plurality of languages. That is, according to the supported language, a separate stream can be further included. For example, when the supported language is English, English audio or subtitles can be included; when it is Japanese, Japanese audio or subtitles can be included; and when it is Korean, Korean audio or subtitles can be included. Accordingly, audio or subtitles supporting a variety of languages can be provided.

Meanwhile, the interactive graphic stream enables a user to change the reproduction time by selecting a chapter or a title, or provides functions for interaction with the user, for example, a function to change settings of a reproduction apparatus, such as the mute function. Thus, the interactive graphic stream for the interactive function is preferably made to support a variety of languages for user convenience.

However, the conventional multimedia storage medium and the reproducing apparatus therefor cannot support a plurality of languages for interactive graphic streams.

### BRIEF DESCRIPTION OF THE DRAWINGS

FIG. 1 is a diagram explaining a method for changing menus supporting a plurality of languages according to the present invention;

FIG. 2 is a diagram showing the structure of a moving picture main stream supporting a plurality of languages according to the present invention;

FIG. 3 is a diagram explaining a display set forming an interactive graphic stream shown in FIG. 2 according to the present invention;

FIG. 4 is a diagram explaining a composition segment including a plurality of menu pages according to a preferred embodiment of the present invention;

FIG. 5 is a diagram explaining a menu page including a plurality of button groups according to a preferred embodiment of the present invention;

FIG. 6 is a diagram showing the structure of a reproducing apparatus for reproducing a menu supporting a plurality of languages according to the present invention;

FIG. 7 is a flowchart of the operations performed by a method for seamlessly reproducing interactive graphic streams supporting a plurality of languages according to a preferred embodiment of the present invention;

FIG. 8 is a diagram showing the structure of a menu page supporting a plurality of languages according to a preferred embodiment of the present invention; and

FIG. 9 is a diagram showing the structure of data specifying a language of a menu to be reproduced first according to a preferred embodiment of the present invention.

### DETAILED DESCRIPTION OF THE INVENTION

### Technical Goal of the Invention

The present invention provides a storage medium having a data structure for seamlessly reproducing interactive graphic streams supporting multiple languages, and an apparatus and method therefor.

### Disclosure of the Invention

According to an aspect of the present invention, there is provided a storage medium including: a main stream generated by compressing and encoding a multimedia image; and a plurality of interactive graphic streams multiplexed into the main stream and forming a menu supporting a plurality of languages, wherein the plurality of interactive graphic streams include page information on a plurality of menu pages, and button information on a plurality of buttons included in each menu page.

### EFFECT OF THE INVENTION

Accordingly, by providing a storage medium storing a plurality of interactive graphic stream supporting a plurality of languages or interactive graphic streams including a plurality of buttons supporting respective languages, and a reproduction apparatus and method therefor, a menu supporting a language selected by a user can be provided. Also, even when a switch operation between menus supporting a plurality of languages is performed, seamless reproduction is enabled.

### BEST MODE FOR CARRYING OUT THE INVENTION

According to an aspect of the present invention, there is provided a storage medium including: a main stream generated by compressing and encoding a multimedia image; and a plurality of interactive graphic streams multiplexed into the main stream and forming a menu supporting a plurality of languages, wherein the plurality of interactive graphic streams include page information on a plurality of menu pages, and button information on a plurality of buttons included in each menu page.

The interactive graphic stream may include a plurality of screen display units, including information on an object forming a menu screen and output control information controlling the output of the object, and the page information and the information on the plurality of buttons may be included in the output control information.

According to another aspect of the present invention, there is provided an apparatus for reproducing data from a storage medium on which a main stream generated by compressing and encoding a multimedia image and a plurality of interactive graphic streams multiplexed into the main stream and forming a menu supporting a plurality of languages are recorded, the apparatus including: a graphic decoder which decodes and reproduces the interactive graphic stream; and a memory area which stores the number of an interactive graphic stream to be reproduced or being currently reproduced among the plurality of interactive graphic streams, the identifier of a menu page to be reproduced or being currently reproduced among a plurality of menu page information items, and the identifier of a button to be reproduced or being currently reproduced among a plurality of button information items.

By referring to the number of the interactive graphic stream stored in the memory area, the graphic decoder may selectively decode only the interactive graphic stream corresponding to the number among the plurality of interactive graphic streams.

The graphic decoder may receive a menu change request from a user and reset the interactive graphic stream number in the memory area so that a menu in a language desired by the user is displayed.

According to still another aspect of the present invention, there is provided a method for reproducing data from a storage medium on which a main stream generated by compressing and encoding a multimedia image and a plurality of interactive graphic streams multiplexed into the main stream and forming a menu supporting a plurality of languages are recorded, the method including: if a menu change request for switching to a menu in a selected language is generated, determining whether or not the number of an interactive graphic stream for the menu in the selected predetermined language is valid; and if the stream number is valid, by referring to the stream number, reproducing selectively only the interactive graphic stream with the number among the plurality of interactive graphic streams.

According to yet still another aspect of the present invention, there is provided a storage medium including: a main stream generated by compressing and encoding a multimedia image; and an interactive graphic stream multiplexed into the main stream and forming a menu supporting a plurality of languages, wherein the interactive graphic stream includes: page information on a plurality of menu pages; a plurality of button information items included in each of the menu page; and language information on the plurality of buttons.

According to a further aspect of the present invention, there is provided an apparatus for reproducing data from a storage medium on which a main stream generated by compressing and encoding a multimedia image and an interactive graphic stream multiplexed into the main stream and forming a menu supporting a plurality of languages are recorded, the apparatus including: a graphic decoder which decodes and reproduces the interactive graphic stream; and a memory area which stores the identifier of a menu page to be reproduced or being currently reproduced among a plurality of menu page information items, and the identifier of a button of a language to be reproduced or being currently reproduced among a plurality of button information items distinguished by language information.

According to an additional aspect of the present invention, there is provided a method for reproducing data from a storage medium on which a main stream generated by compressing and encoding a multimedia image and an interactive graphic streams multiplexed into the main stream and forming a menu supporting a plurality of languages are recorded, the method including: if a menu change request for switching to a menu in a selected predetermined language is generated, determining whether or not the button identifier of the selected predetermined language is valid; and if the button identifier is valid, by referring to the button identifier, selectively reproducing only the button corresponding to the button identifier among the plurality of button information items distinguished by the language information.

### EMBODIMENTS

The present invention will now be described more fully with reference to the accompanying drawings, in which exemplary embodiments of the invention are shown.

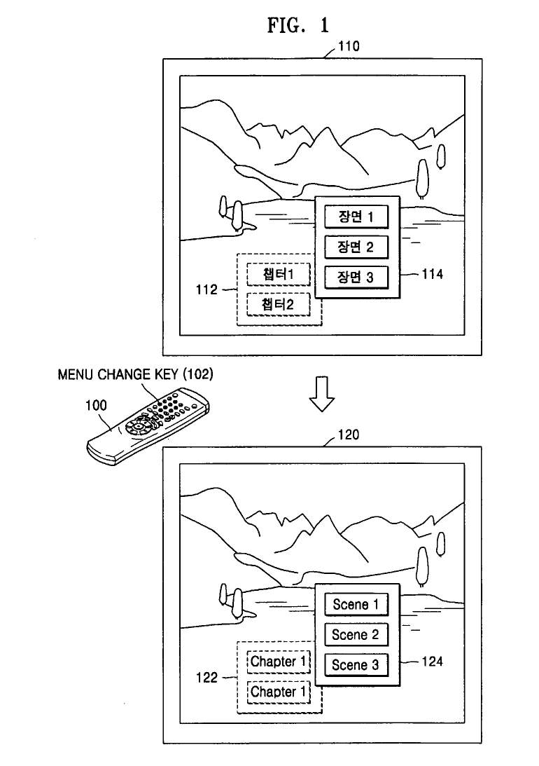

FIG. 1 is a diagram explaining a method for changing menus supporting a plurality of languages according to the present invention.

FIG. 1 shows a display apparatus 110 and 120 displaying a multimedia image, and a remote controller 100 as a user interface supporting interaction with a user. In the display apparatus 110 connected to a reproducing apparatus (not shown) according to a preferred embodiment of the present invention, a menu screen 112 and 114 including a plurality of buttons for interaction with a user can be displayed together with a multimedia image as shown at the top of FIG. 1. Also, a plurality of menu screens such as the menu screen including the plurality of buttons as shown in FIG. 1 can be provided.

At this time, the bottom figure shows that if the user pushes a menu change key 102 according to the present invention, included in the remote controller 100, the menu currently displayed in Korean is changed to a menu 122 and 124 in English. At this time, in order to guarantee seamless reproduction even when the menu is changed to another menu supporting a plurality of languages, the menu page currently displayed, the button group included in the menu page, and a selected button number should be specified. That is, only when the reproducing apparatus knows the menu page currently displayed, the button group and the button number, even if the menu is changed to an interactive graphic stream with a different language according to a menu change request by the user, a new menu and buttons in the new language corresponding to the menu and buttons currently being displayed can be displayed on the screen.

A storage medium having a data structure capable of seamless reproduction even when switching between menus supporting a plurality of languages will now be explained.

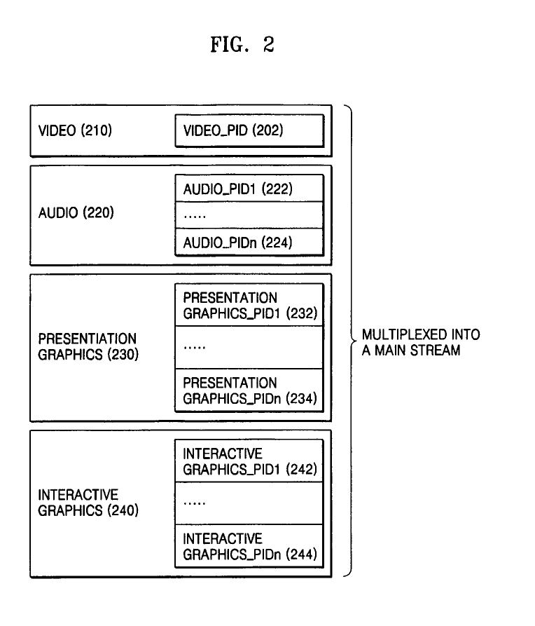

FIG. 2 is a diagram showing the structure of a moving picture main stream supporting a plurality of languages according to the present invention.

Referring to FIG. 2, in the storage medium according to the present invention each stream is multiplexed and written in a main stream. The main stream for providing a multimedia image includes a video stream 210 generated by compressing and encoding a moving picture, audio streams 220 generated by compressing and encoding a plurality of voice information items, a plurality of presentation graphic streams 230 for providing subtitles, and a plurality of interactive graphic stream 240 for providing menus. In particular, in addition to the plurality of audio streams and presentation graphic streams, the plurality of interactive graphic streams according to the present invention are included in order to support a plurality of languages.

Each of the plurality of stream data items is distinguished by a packet identification (PID) which is an identifier of a packet data item. For example, if PID 1 supports Korean, then the audio stream 222, the presentation graphic stream 232, and the interactive graphic stream 242 corresponding to PID 1 support Korean. In the same manner, PID 2 and PID 3 can respectively be specified to support English and Japanese.

With the interactive graphic streams 240, a variety of menus can be expressed, including a general menu for selecting a title or a scene at the beginning of reproduction of a multimedia image, a pop-up menu that can be overlaid on a moving picture screen during reproduction of the moving picture such as a movie, and an always-on menu that is always displayed.

The data structure of the interactive graphic stream 240 for reproducing these menus will now be explained in more detail.

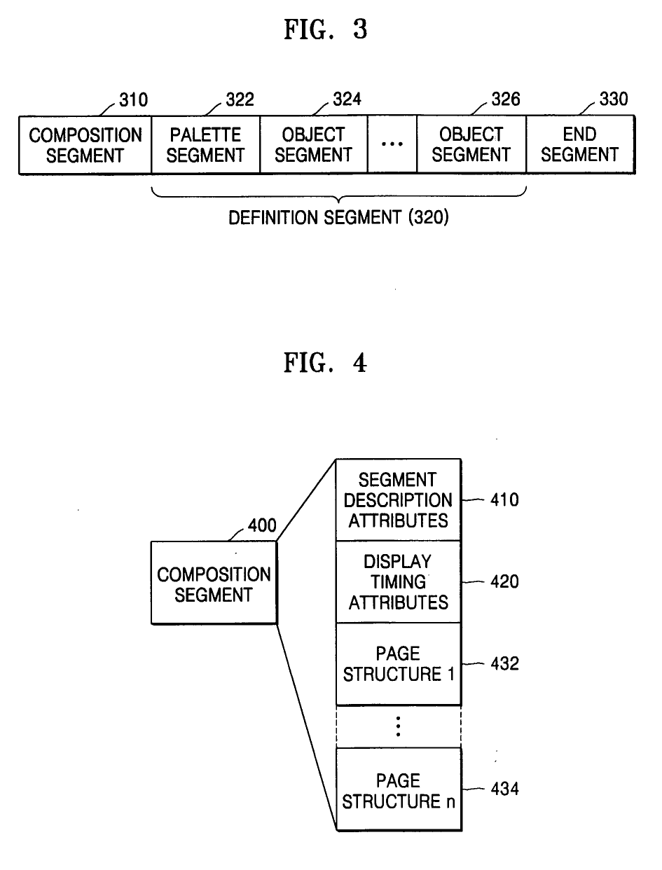

FIG. 3 is a diagram explaining a display set forming the interactive graphic stream 240 shown in FIG. 2 according to the present invention.

Referring to FIG. 3, the display set indicates a set of information items required for displaying one menu on the screen. The interactive graphic stream 240 includes a plurality of these display sets. The display set included in the interactive graphic stream 240 includes the following segments.

First, a composition segment 310 is a segment indicating the start of the display set, and includes attribute information of the display set, information on a plurality of menu pages, and time information.

Next, a definition segment 320 includes information defining the image of a menu object to be actually displayed. A palette segment 322 included in the definition segment 320 defines color information to be applied to the image of the menu object for providing a plurality of menus. Object segments 324 through 326 define bitmap image information expressing the image of menu objects for providing a plurality of menus. A plurality of object segments can be included in one display set.

Finally, an end segment 330 indicates the end of the display set.

The data structure of the composition segment 310 to support a plurality of languages according to the present invention will now be explained in more detail.

FIG. 4 is a diagram explaining a composition segment including a plurality of menu pages according to a preferred embodiment of the present invention.

Referring to FIG. 4, the composition segment 400 includes a plurality of page structures 432 through 434. Accordingly, a plurality of menu pages that can be displayed in a valid display period in which one display set is displayed can be provided. Each page is distinguished from other pages by a unique page identifier, and at any one time, only one menu page having a certain page identifier among the plurality of page structures included in the composition segment 400 is displayed. Accordingly, as shown in FIG. 1, in a valid display period, the menu screen 112 for selecting a chapter, or the menu screen 113 for selecting a scene can be displayed on the screen.

A data structure capable of displaying a plurality of buttons such as chapter 1 and chapter 2 or scene 1, scene 2 and scene 3 included in each menu screen in a plurality of languages will now be explained.

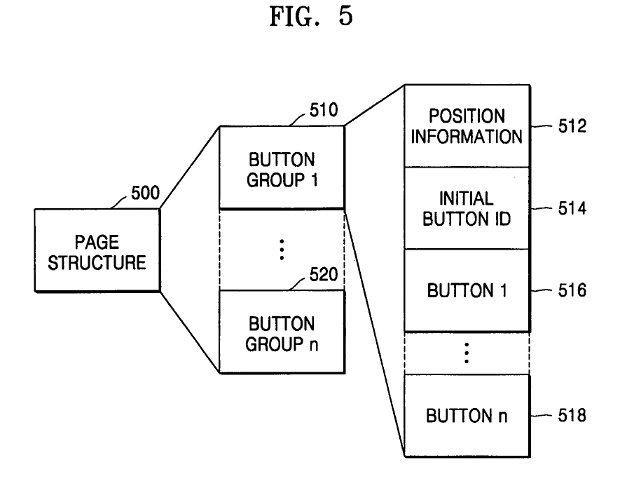

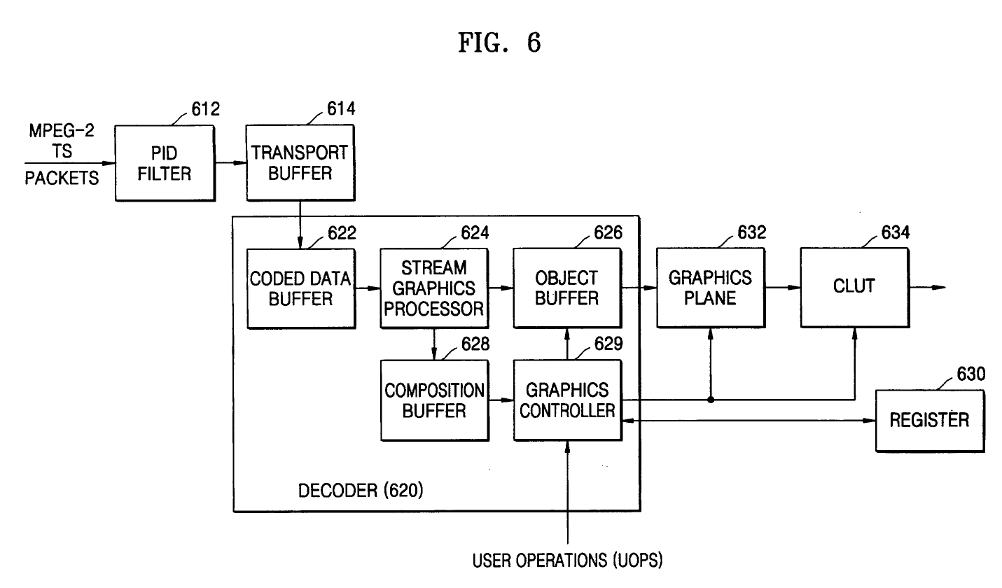

FIG. 5 is a diagram explaining a menu page including a plurality of button groups according to a preferred embodiment of the present invention.

Referring to FIG. 5, each page structure 500 described above with reference to FIG. 4 includes a plurality of button groups 510 through 520. Each button group 510 includes a plurality of button information items 516 through 518. The button group 510 is a set of buttons that can be displayed on an identical location of a graphic plane to be explained later. Each of the buttons included in one button group has a unique button identifier 516 through 518 so that the button can be distinguished from other buttons. At any one time, one button specified in each button group is collected to form one menu page. Referring to FIG. 1, in the menu screen 112 for selecting a chapter, there are two button groups, chapter 1 and chapter 2. In the chapter 1 button group, n buttons from button 1 to button 2 can be included.

However, in order to avoid confusion of the user, it is preferable that a plurality of buttons included in a button group have identical button numbers. That is, if a plurality of buttons 1 through n are included in the chapter 1 button group, it is preferable that the chapter 2 button group also has a plurality of buttons with identical button numbers.

Accordingly, the button group may include the location information of buttons commonly applied to the buttons in the button group and identifier information on the button to be first displayed in the button group.

As described above, in order to specify one button included in a menu screen being currently displayed, it is needed to specify the PID identifier of the interactive graphic stream shown in FIG. 2, the page identifier in the composition segment included in the display set shown in FIGS. 3 and 4, and the button group number and the button identifier shown in FIG. 5.

The same number of interactive graphic streams as the supported languages are multiplexed and included. In each interactive graphic stream, an identical number of page structures, an identical number of button groups, and an identical number of buttons are included.

Accordingly, if the PID identifier of an interactive graphic stream according to a language to be displayed on the screen is set, a menu screen of the language corresponding to the PID identifier can be displayed. Also, by remembering the page identifier and button identifier which are currently reproduced, if the interactive graphic stream is changed to another one, a menu including buttons corresponding to the same page identifier and button identifier in the new interactive graphic stream as those in the previous interactive graphic stream can be displayed on the screen. Accordingly, when a switch between menus supporting a plurality of languages is performed, buttons and menu of a different language version from those previously displayed are displayed, such that seamless reproduction can be guaranteed.

The structure of an apparatus for reproducing a menu supporting a plurality of languages based on the data structure forming each menu described above will now be explained.

FIG. 6 is a diagram showing the structure of a reproducing apparatus for reproducing a menu supporting a plurality of languages according to the present invention.

Referring to FIG. 6, the reproducing apparatus according to the present invention includes a PID filter 612, a transmission buffer 614, a graphic decoder 620, a graphic plane 632, a color lookup table (CLUT) 634, and a register 630.

The input to the reproducing apparatus according to the present invention is a main stream (Refer to FIG. 2) including interactive graphic streams forming a menu screen, and is compressed and encoded in the form of an MPEG-2 transport stream.

The PID filter 112 selects transport packets having an identical PID from the MPEG-2 transport stream that is multiplexed, and transfers the packets to the transmission buffer 114.

By using the transport packets having an identical PID, the transmission buffer 114 combines a packetized elementary stream (PES), and then, if it is time for decoding (decoding time stamp, hereinafter referred to as a DTS) or a time for presentation (presentation time stamp, hereinafter referred to as a PTD) included in the header of the PES packet, the header of the transport packet and the header of the PES packet are removed and the main stream is transmitted to the graphic decoder 620.

The graphic decoder 620 decodes the received main stream in order to output a graphic image, subtitles or menus. The graphic decoder 620 includes a coding data buffer 622, a stream graphic processor 624, an object buffer 626, a composition buffer 628, and a graphic controller 629.

The coding data buffer 622 receives packets in units of PESs from the transmission buffer 664 described above, and then, if it is the DTS or PTS time indicated by the header of the PES packet, transfer the packets in units of PESs so that decoding can start.

According to the structure of the display set described above with reference to FIG. 3, the stream graphic processor 624 transfers information on a menu object image to be output on the screen, to the object buffer 626, and transfers composition information to control the output of a menu object image, to the composition buffer 628.

According to the output control information in the composition buffer 628, if it is the PTS time, the graphic controller 629 controls a menu object image stored in the object buffer 626 to be generated on the graphic plane 632, and by adding color information of the CLUT 634 (a color reference table), the image is output on the screen. Thus, the interactive graphic stream transferred to the graphic decoder 620 is processed according to the role of each segment of the display set described above.

Meanwhile, when a desired language is selected in the data structure described above with reference to FIGS. 2 through 5, and buttons and menu are displayed on the screen, in order to guarantee seamless reproduction, the register 630 stores identifier information of the buttons and menu currently displayed.

The conditions required for seamless reproduction of interactive graphic streams supporting a plurality of languages based on the structure of the reproducing apparatus according to the present invention described above will now be explained.

As shown in FIG. 1, when a multimedia image such as a movie is reproduced, if the user wants to change a currently displayed menu to a different language, the switch between the interactive graphic streams shown in FIG. 2 should be performed. At this time, in order to seamlessly reproduce a menu page supporting a new language following the menu page navigated immediately before, it is preferable to put the following constraints on interactive graphic streams.

That is, in each of the plurality of interactive graphic streams (Refer to FIG. 2) that are generated to support a plurality of languages, only objects for displaying buttons have different images according to the language. Other information items, such as commands to be executed if each button is pushed, or the location in which each button is displayed, should be generated identically.

In a switch between interactive graphic streams satisfying this condition, even though a switch between interactive graphic streams is performed by a selection of a language during the navigation of the previous menu, seamless menu navigation is enabled.

Meanwhile, when a switch between interactive graphic streams is performed by a selection of a language during the menu navigation as described above, in order to continue the menu navigation from the same location, it is preferable that the reproducing apparatus has the following register areas 630 capable of storing information:

1) A first register area storing the number of an interactive graphic stream to be reproduced or being currently reproduced;

2) A second register area storing the page identifier of a page structure to be reproduced or being currently reproduced; and

3) A third register area storing the button identifier of a button that should be displayed in a plurality of button groups in order to form a menu page according to the page structure to be reproduced or being currently reproduced, in the page structure.

Also, when a plurality of interactive graphic streams for menus supporting a plurality of languages are generated, in order for the user to select one of the plurality of interactive graphic streams, it is preferable to include a user manipulation function (a user operation) for menu change as the following:
Menu_Change(Interactive Graphics Stream Number)

Here, the interactive graphics stream number is the PID number (Refer to FIG. 2) of an interactive graphic stream forming a menu of the language which the user want to use after the change. The function for the menu change resets the value of the first register storing the number of the interactive graphic stream to be reproduced or being currently reproduced, with the interactive graphic stream number value that is the argument of the function. According to this, a menu in the language desired by the user is displayed on the screen. If there is no valid interactive graphic stream number, this operation is ignored.

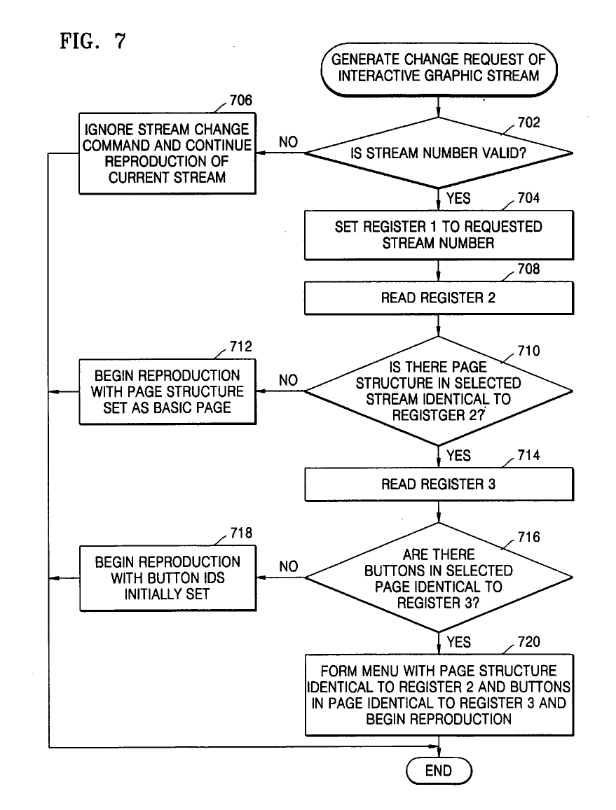

FIG. 7 is a flowchart of the operations performed by a method for seamlessly reproducing interactive graphic streams supporting a plurality of languages according to a preferred embodiment of the present invention.

FIG. 7 shows the process for the case when there is a request from a user for changing an interactive graphic stream, for example, when the user pushes the menu change key 102 of the remote controller 100 shown in FIG. 1 and a user operation is generated.

If the interactive graphic stream number requested by the user is a valid value, in operation 702, the reproducing apparatus resets the value of a first register to the requested interactive graphic stream number, in operation 704. If the requested number is an invalid value, it is preferable that the request by the user for changing the stream is ignored and the reproduction of a menu by an interactive graphic stream being currently reproduced is continued, in operation 706.

Next, the reproducing apparatus reads a second register in operation 708, and confirms whether or not the requested interactive graphic stream includes a page structure having a page identifier set in the second register in operation 710. If the page structure satisfying this is not included, it is preferable that a default page is displayed or the page structure having a page identifier with the smallest value is displayed, in operation 712.

Next, if the number of the requested interactive graphic stream number is valid and a page structure having the page identifier set in the second register is included, the reproducing apparatus reads a third register in operation 714, and confirms whether or not there are buttons satisfying button identifiers set in the third register and required to form a menu page that should be displayed according to a page structure, in operation 716. If there are no button identifiers satisfying the button identifier set in the third register, it is preferable that by using button ID information (514 of FIG. 5) initially set and included in a plurality of button groups in a page structure, buttons to be displayed are selected to form a page and the page is displayed.

If the conditions described above are all satisfied, that is, if a switch between interactive graphic streams satisfying the constraints for seamless reproduction of interactive graphic streams described above is performed, a menu is formed with buttons corresponding to identifiers set in the second register and the third register, and the reproduction begins. Accordingly, by the menu change request, buttons and menu in a new language, corresponding to the buttons and menu being currently reproduced, can be displayed on the screen. That is, seamless menu navigation is enabled, following the menu navigation before the menu change request.

Meanwhile, a second embodiment of seamless reproduction between interactive graphic streams supporting a plurality of languages will now be explained.

In the embodiment described above with reference to FIGS. 2 through 7, the case in which the plurality of interactive graphic streams 240 as shown in FIG. 4 are multiplexed in the main stream is explained.

The second embodiment of the present invention to be described now relates to the case where interactive graphic streams are not multiplexed in the main stream as described with reference to FIG. 2, but are in the form of a separate file. When the interactive graphic streams are in the form of a file separate from the main stream, the interactive graphic streams are preloaded and reproduced. If the capacity of a buffer for preloading is enough to preload all of a plurality of interactive graphic stream files generated to support a plurality of languages, seamless reproduction can be guaranteed by the same method as the embodiment described above.

However, since an unlimited buffer size cannot be assumed, the present invention suggests the following method in order to use a buffer with a limited capacity and at the same time guarantee seamless reproduction when changing menus supporting a plurality of languages. In the method according to the second embodiment of the present invention, in order to support a plurality of languages, only one interactive graphic stream is used. This is because the capacity of a buffer is limited as described above.

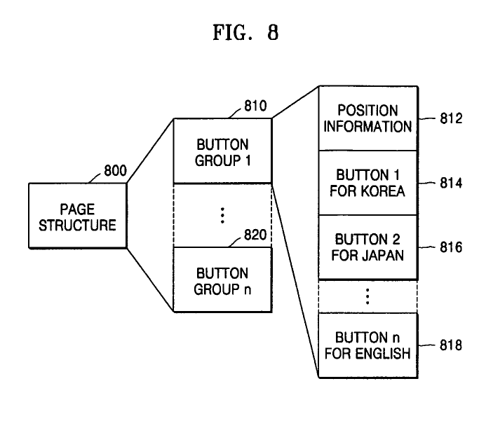

FIG. 8 is a diagram showing the structure of a menu page supporting a plurality of languages according to a second embodiment of the present invention.

According to the second embodiment of the present invention, in order to support a plurality of languages, instead of using a plurality of interactive graphic streams, one interactive graphic stream is used regardless of the language. Referring to FIGS. 5, 6, and 8, a page structure for each menu page is formed with a plurality of button groups. A button group is a set of buttons that can be displayed in the same location of the graphic plane 632. However, a button group 810 according to the second embodiment of the present invention is formed with a plurality of buttons 812 through 818 each having a unique button identifier. It is preferable that language information of each button is included with the button in addition to the unique identifier.

Also, a button identifier can be specified with respect to a supported language. Accordingly, instead of including a plurality of interactive graphic streams, in the second embodiment of the present invention, in order to support a plurality of languages, a plurality of buttons each supporting a plurality of languages are defined in one interactive graphic stream so that a menu supporting a plurality of languages can be provided.

Meanwhile, referring to FIGS. 5 and 8, information indicating a button identifier that should be first displayed in a button group, such as the button ID 514 initially set as in the embodiment shown in FIG. 5, is not included in the second embodiment of the present invention. Instead, in the second embodiment of the present invention, identifier information on the button to be first displayed has the following data structure.

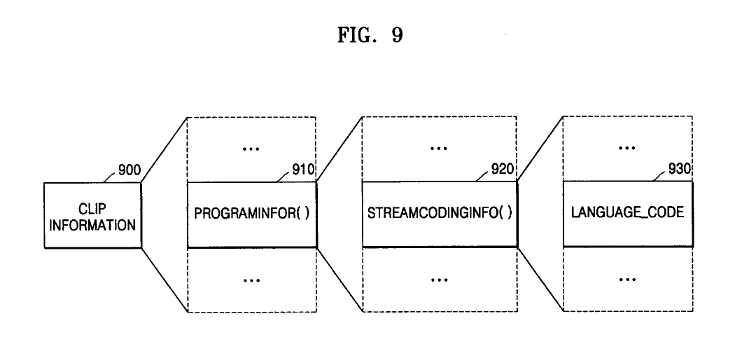

FIG. 9 is a diagram showing the structure of data specifying a language of a menu to be reproduced first according to the second embodiment of the present invention.

Referring to FIG. 9, information indicating language information that should be first displayed in the interactive graphic stream according to the second embodiment of the present invention is included in clip information 900, which includes attribute information of the interactive graphic stream. According to the second embodiment of the present invention, the interactive graphic stream is not multiplexed in the main stream, but is in the form of a separate file. Therefore it is preferable that information on the language that is to be first reproduced is included in the clip information 900 having attribute information on the reproduction of a multimedia image. That is, preferably, language_code in the clip information is used as shown in FIG. 9.

In the clip information 900, which has information on a variety of attributes of the interactive graphic stream, there is streamcoding info( ) 920 in programinfo( ) 910 as an area including coding information of the interactive graphic stream specified by the clip information, and in this area, the language_code 930, that is the language information of the interactive graphic stream, can be included. Accordingly, it is preferable that this language information area 930 is used as the language information that should be first displayed in the interactive graphic stream to support a plurality of languages.

As described above, when one interactive graphic stream includes all buttons for supporting a plurality of languages, if a switch between buttons of different languages is performed during a menu navigation, in order to implement seamless reproduction, it is preferable that the reproducing apparatus has the following register areas capable of storing information:

1) A first register area storing the number of an interactive graphic stream to be reproduced or being currently reproduced; and

2) A second register area storing language information of a button displayed in the page structure to be reproduced or being currently reproduced.

Also, when a storage medium on which an interactive graphic stream including buttons supporting a plurality of languages is recorded is reproduced, in order for the user to change a menu to a desired language, it is preferable that the reproducing apparatus has a user manipulation function (a user operation) for menu change as the following:

Menu_Change( )

The menu change function changes a menu in an interactive graphic stream number, in an increasing order or in another order from the button identifier of a button having the selected language information from a button group in the page structure being currently displayed. The menu change function resets language information newly selected by the user to the second register.

According to this, in the storage medium according to the second embodiment of the present invention, as described with reference to FIGS. 8 and 9, by including buttons supporting a plurality of languages in one interactive graphic stream, seamless reproduction between menus supporting a plurality of languages is enabled even though the interactive graphic stream exists separate from the main stream.

Since an apparatus and method for reproducing the storage medium according to the second embodiment of the present invention are based on the same principles as the apparatus and method according to the first embodiment, the explanation with reference to FIGS. 6 and 7 can be applied equally to the apparatus and method according to the second embodiment.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

1. A storage medium for use with a reproducing apparatus, the storage medium comprising:
a main stream generated by compressing and encoding a multimedia image and from which the apparatus generates the multimedia image for display; and
a plurality of interactive graphic streams multiplexed into the main stream and which the apparatus uses to form a menu for each of a plurality of languages, the plurality of interactive graphic streams each include for a corresponding one of the plurality of languages:
page information on a plurality of menu pages which the apparatus displays in the one language; and
button information on a plurality of buttons included in each menu page which the apparatus displays in the one language.

2. The storage medium of claim 1, wherein:
the interactive graphic stream includes a plurality of screen display units, each screen display unit including information on an object used by the apparatus in forming a menu screen and output control information used by the apparatus in controlling the output of the object, and
the output control information comprises the page information and the button information.

3. The storage medium of claim 2, wherein the page information of the output control information further includes first display information used by the apparatus to determine which button the apparatus is to first display.

4. The storage medium of claim 3, wherein the screen display unit is a display set and the output control information is a composition segment.

5. An apparatus for reproducing data from a storage medium on which are recorded a main stream generated by compressing and encoding a multimedia image and a plurality of interactive graphic streams multiplexed into the main stream and forming a menu supporting a plurality of languages, the apparatus comprising:
a memory area which stores an interactive graphic stream number of a selected one of a plurality of the interactive graphic streams to be reproduced or being currently reproduced, a menu page identifier of a menu page to be reproduced or being currently reproduced selected from among a plurality of menu page information items, and a button identifier of a button to be reproduced or being currently reproduced selected from among a plurality of button information items; and
a graphic decoder which decodes and reproduces the selected one of the interactive graphic streams according to the stored interactive graphic stream number, the stored menu page identifier, and the stored button identifier.

6. The apparatus of claim 5, wherein the graphic decoder selectively decodes only the one of the interactive graphic streams in the main stream corresponding to the number among the plurality of interactive graphic streams by referring to the number of the interactive graphic stream stored in the memory area.

7. The apparatus of claim 6, wherein the graphic decoder receives a menu change request from a user and changes the stored interactive graphic stream number in the memory area to another interactive graphic stream number and uses the stored replaced interactive graphic stream number to select a corresponding other one of the plurality of interactive graphic streams so that a menu in a language desired by the user is displayed using the other interactive graphic stream.

8. The apparatus of claim 7, wherein the graphic decoder includes a user function which changes the memory area according to the menu change request.

9. A method of reproducing data from a storage medium on which are recorded a main stream generated by compressing and encoding a multimedia image and a plurality of interactive graphic streams multiplexed into the main stream and forming a menu supporting a plurality of languages, the method comprising:
when a menu change request is generated for switching to a menu in a selected language from the menu in a current language, determining whether a stream number of an interactive graphic stream for the menu in the selected predetermined language is valid; and
when the stream number is determined to be valid, selectively reproducing only the interactive graphic stream with the valid stream number among the plurality of interactive graphic streams having corresponding stream numbers by referring to the valid stream number.

10. A storage medium for use with a reproducing apparatus, the storage medium comprising:
a main stream generated by compressing and encoding a multimedia image and from which the apparatus generates the multimedia image for display; and
an interactive graphic stream multiplexed into the main stream and which the apparatus uses to form a menu supporting each of a plurality of languages, the interactive graphic stream comprising, for each of the plurality of languages:
page information on a plurality of menu pages which the apparatus displays in the one language;
a plurality of button information items included in each menu page which the apparatus displays in the one language; and
language information on the plurality of buttons.

11. (canceled)

12. (canceled)

13. (canceled)

14. An apparatus for reproducing data from a storage medium on which are recorded a main stream generated by compressing and encoding a multimedia image and an interactive graphic stream multiplexed into the main stream and forming a menu supporting a plurality of languages, the apparatus comprising:
a memory area which stores a menu page identifier of a menu page to be reproduced or being currently reproduced selected from among a plurality of menu page information items, and a button identifier of a button of a language to be reproduced or being currently reproduced selected from among a plurality of button information items distinguished by language information; and
a graphic decoder which decodes and reproduces the interactive graphic stream in a selected one of the languages according to the stored menu page identifier and the stored button identifier.

15. The apparatus of claim 14, wherein the graphic decoder selectively decodes the button of the corresponding language by referring to the page identifier stored in the memory area and the button identifier as distinguished by the language information.

16. The apparatus of claim 15, wherein the graphic decoder receives a menu change request from a user and changes the button information as distinguished by the language information in the memory area and displays a menu in another language desired by the user.

17. The apparatus of claim 16, wherein the graphic decoder includes a user function for resetting the memory area due to the menu change request.

18. A method of reproducing data from a storage medium on which are recorded a main stream generated by compressing and encoding a multimedia image and an interactive graphic stream multiplexed into the main stream and forming a menu supporting a plurality of languages, the method comprising:
when a menu change request is generated for switching to a menu in a selected language from the menu in a current language, determining whether a button identifier of the selected predetermined language is valid; and
if the button identifier is determined to be valid, selectively reproducing only a button corresponding to the button identifier using button information selected from among a plurality of button information items as distinguished from each other by the language information by referring to the valid button identifier.

19. A storage medium for use with a reproducing apparatus, the storage medium comprising:
a main stream including a compressed and encoded multimedia image and from which the apparatus generates the multimedia image for display; and
at least one interactive graphic stream which the apparatus uses to form an interactive menu for a selected one of a plurality of languages;
page information on a plurality of displayable menu pages which the apparatus uses to display one or more of the menu pages of the interactive menu in the selected one language; and
button information on a plurality of buttons included in each menu page from which the apparatus displays one or more of the buttons in the displayed one or more menu pages of the interactive menu corresponding to the one selected language.

20. The storage medium of claim 19, further comprising language identification information which correlates which of the buttons, menu pages, and menus are displayed according to each of the plurality of languages and which the apparatus uses to identify and select the menu, the one or more menu pages, and the one or more buttons according to the selected one language.

21. The storage medium of claim 20, wherein:
the at least one at least one interactive graphic stream comprises a plurality of interactive graphic streams, each interactive graphic stream uniquely corresponding to one of the plurality of languages and including a packet identification (PID) as the language identification information, and
in order to display the interactive menu in the selected one of the languages, the apparatus selects the PID for the selected language and reproduces the interactive graphic stream which correlates which of the buttons, menu pages, and menus are displayed according to the one of the languages unique to the PID.

22. The storage medium of claim 20, wherein:
the at least one at least one interactive graphic stream is a single interactive graphic stream, and
each of the buttons of the button information uniquely corresponds one of the plurality of languages and has a button identifier to identify a language of the corresponding to the button.

23. The storage medium of claim 22, further comprising a clip information file including a language code as the language identification information which the apparatus detects and uses to identify which one the languages is selected prior to receipt of an input to select one of the languages.

24. An apparatus for reproducing a multimedia image stream from a storage medium storing one or more streams of data, the apparatus comprising:
a reader which reads the multimedia image stream from the storage medium and outputs a main stream including a compressed and encoded multimedia image, at least one interactive graphic stream, page information on a plurality of displayable menu pages, and button information on a plurality of buttons included in each menu page; and
a controller which reproduces the output main stream and controls the output of the reproduced multimedia image to a display, reproduces the at least one interactive graphic stream and forms an interactive menu for a selected one of a plurality of languages on the display, reproduces the page information and controls the display of one or more of the menu pages of the formed interactive menu in the selected one language, and reproduces the button information and controls the display of one or more of the buttons in the displayed one or more menu pages of the displayed interactive menu in the one selected language.

25. The apparatus claim 24, wherein the multimedia image stream further comprises language identification information which correlates which of the buttons, menu pages, and menus are displayed according to each of the plurality of languages, and the controller uses the language identification to identify and select the menu, the one or more menu pages, and the one or more buttons to be displayed according to the selected one language.

26. The apparatus of claim 25, wherein:
the at least one at least one interactive graphic stream comprises a plurality of the at least one interactive graphic streams,
each interactive graphic stream uniquely corresponds to one of the plurality of languages and includes a packet identification (PID) as the language identification information, and
in order to display the interactive menu in the selected one of the languages, the controller selects the PID for the selected language and reproduces the interactive graphic stream which correlates which of the buttons, menu pages, and menus are displayed according to the one of the languages unique to the PID.

27. The apparatus of claim 25, wherein:
the at least one at least one interactive graphic stream is a single interactive graphic stream having buttons,
each of the buttons of the button information uniquely corresponds one of the plurality of languages and has a button identifier to identify a language of the corresponding to the button, and
the controller reads the single interactive graphic stream from a file structure of the storage medium in which the single interactive graphic stream is in a file separate from a file including the main stream.

28. The apparatus of claim 27, wherein:
the storage medium further comprises a clip information file including a language code as the language identification information, and
the controller detects and uses the language code to identify which one the languages is selected prior to receipt of an input to select one of the languages.

29. The apparatus of claim 24, further comprising a memory area which stores a menu page identifier of a menu page to be reproduced or being currently reproduced selected from among a plurality of items including the page information for each corresponding language, and a button identifier of a button of a language to be reproduced or being currently reproduced selected from among a plurality of items of the button information for each corresponding language, wherein the controller reproduces the interactive graphic stream according to the stored menu page identifier and the stored button identifier.

30. The apparatus of claim 29, wherein the controller receives a menu change request and, due to the received menu change request, changes the button information stored in the memory area to button information for another one of the languages, and displays another interactive menu in the another language according to the changed button information stored in the memory area.
